(19) United States
(12) Patent Application Publication
(10) Pub. No.: US 2006/0235175 A1
(43) Pub. Date: Oct. 19, 2006

(54) Synthesis and characterization of novel functional fluoropolymers

(76) Inventors: Bilal Baradie, North York (CA); Molly S. Shoichet, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 11/402,269

(22) Filed: Apr. 12, 2006

Related U.S. Application Data
(60) Provisional application No. 60/671,461, filed on Apr. 15, 2005.

(51) Int. Cl. C08F 214/18

(52) U.S. Cl. 526/249; 526/250; 526/255; 526/335; 526/317.1; 526/266; 526/319; 526/279

(57) ABSTRACT

Functional fluoropolymers of a fluorocarbon, interlinker and siloxane monomers have been synthesized by free radical polymerization in supercritical fluid carbon dioxide wherein the interlinker monomer is necessary for the copolymerization of the fluoromonomer and the siloxane monomer. Furthermore, the addition of a crosslinking agent to the functional fluoropolymer produces a highly thermally stable and elastic film wherein the film properties can be controlled for specific applications such as coatings, including in paints, and biomedical devices.

### CROSS REFERENCE TO RELATED APPLICATION

This patent application claims the priority benefit from U.S. Provisional Patent Application Ser. No. 60/671,461 filed on Apr. 15, 2005 entitled SYNTHESIS AND CHARACTERIZATION OF NOVEL FUNCTIONAL FLUOROPOLYMERS, which is incorporated herein by reference in its entirety.

### FIELD OF THE INVENTION

The present invention relates generally to the synthesis of a series of novel functional polymers and polymerizations carried out in supercritical carbon dioxide to provide functional polymers that are chemically and thermally stable, hydrophobic, and more elastomeric than commercial fluoropolymers. Specifically, the invention is a functional fluoropolymer with a fluorocarbon backbone, an interlinker monomer, and a siloxane monomer wherein the resulting fluoropolymer exhibits unique bulk and surface properties.

### BACKGROUND OF THE INVENTION

Fluoropolymers are chemically resistant and thermally stable; polysiloxanes are thermally stable and elastomeric when crosslinked; and both are hydrophobic. To combine the properties of both fluoropolymers and polysiloxanes, there is a need to create a polymer that would be chemically and thermally stable, have very low surface energy and be more elastomeric than commercial fluoropolymers. Currently, fluorosilicones are used commercially as high-temperature lubricants and elastomers because of their excellent chemical, thermal, and thermo-oxidative resistance.

Various polymerization processes have been used to synthesize a wide number of polymers using free radical mechanisms. These processes are primarily emulsion, bulk and solution polymerization.

Polymerizations conducted in carbon dioxide offer many advantages over emulsion polymerization that include minimal environmental impact and better solubility of a selected group of monomers and polymers without the use of a stabilizer or surfactant. For example, a copolymer of tetrafluoroethylene-vinyl acetate is one of those fluoropolymers that presents very good solubility in carbon dioxide over a wide range of copolymer compositions (Shoichet et al. Macromolecules, 2004; Lousenberg et al. U.S. Pat. No. 6,730,762 B2).

Heterogeneous polymerization in carbon dioxide has been described in the prior art, in particular, in U.S. Pat. No. 5,780,553 to DeSimone et al. This patent discloses a method of carrying out a heterogeneous polymerization of a monomer, a stabilizer precursor and a polymerization initiator in a polymerization medium comprising carbon dioxide. The monomer and the stabilizer precursor are polymerized in the polymerization medium to form a heterogeneous reaction mixture comprising a polymer in the polymerization medium. The stabilizer precursor is covalently bound to the polymer to provide an intrinsic surfactant in the polymer. The stabilizer precursor covalently bonds to and reacts with the monomer, the polymer, and/or the initiator during the polymerization step.

More specifically, the patent teaches reacting one or more of hydrocarbon or fluoromonomers, such as tetrafluoroethylene (TFE), chlorotrifluoroethylene (CTFE), vinyl acetate (VAc) with a stabilizer precursor, such as methacryloxypropyl functional polydimethylsiloxane (PDMSMA), that is used in the reaction mixture to provide an intrinsic surfactant in the polymer which functions to stabilize the polymer in the heterogeneous reaction mixture.

One primary aspect not taught by DeSimone is the importance of incorporating the monomers or mixture of monomers in order to get a stabilized fluoropolymer. The present inventors have shown that reacting tetrafluoroethylene with a stabilizer precursor, such as methacryloxypropyl functional polydimethylsiloxane, in the presence of an initiator, such as, 2,2′-azobis(isobutyro-nitrile), in carbon dioxide as the polymerization medium will lead to the formation of poly(methacryloxypropyl functional polydimethylsiloxane) homopolymer. The same reaction occurs when other fluorocarbon monomers, such as chlorotrifluoroethylene, vinyl fluoride and 1,1-difluoroethylene (VDF), were used instead of tetrafluoroethylene.

In addition, DeSimone et al, does not teach the use of a stabilized precursor in carbon dioxide to produce commercially viable polymers with unique polymer properties, such as thermal and mechanical properties. Fluoropolymers containing fluorocarbon moieties, such as tetrafluoroethylene in the polymer backbone, present higher thermal stability than polymers containing fluorocarbon in the pendant group (DeSimone et al. Journal of Polymer Science: Part A: Polymer Chemistry 2000).

Therefore, it would be very advantageous to provide functional fluoropolymers having fluorocarbon monomers in the polymer backbone that provide thermal stability, chemical resistance, and elasticity.

### SUMMARY OF THE INVENTION

Accordingly, the present invention provides a functional fluoropolymer and a method of synthesis of such a polymer, wherein the polymer exhibits thermal stability, hydrophobicity and elasticity.

The present invention provides a functional polymer comprising a fluorocarbon monomer, an interlinker monomer and a siloxane monomer wherein the interlinker monomer functions to copolymerize siloxane monomer with fluorocarbon monomer rendering a wide range of compositions with a wide range of molecular weights (including high molecular weight) fluoropolymers which will be useful for many coatings and paint applications. Without including the interlinker, only low molecular weight polysiloxane homopolymers can be produced.

Thus in one aspect of the invention there is provided a functional fluoropolymer comprising a fluorocarbon backbone portion including at least one fluorocarbon repeat unit, a siloxane polymer portion including at least one siloxane repeat unit, and an interlinker polymer portion including at least one interlinker repeat unit, the interlinker polymer portion being covalently bound to both the fluorocarbon backbone portion and the siloxane polymer portion. The fluorocarbon repeat unit may be a monomer selected from the group consisting of fluoroolefinic monomers, perfluoroolefinic monomers, and combinations thereof.

Alternatively, the fluorocarbon repeat unit may be a monomer selected from the group consisting of tetrafluoroethylene, trifluoroethylene, chlorotrifluoroethylene (CTFE), vinylidene fluoride (VF₂), α,β,β-trifluoroaromatic monomers, trifluorovinyl ether monomers.

The interlinker repeat unit may be a monomer selected from the group consisting of alkene or diene monomers, styrenic monomers, maleic anhydride monomers, acrylic and methacrylic monomers, olefinic monomers, tertiary butyl acrylate, vinyl acetate, vinyl propionate, vinylic ethers, vinylic esters, and combinations thereof.

Alternatively, the interlinker repeat unit may be a fluoroacrylate monomer selected from the group consisting of 1,1-dihydroperfluorooctyl acrylate (FOA), 1,1-dihydroperfluorooctyl methacrylate (FOMA), 2-(N-ethylperfluorooctanesulfonamido) ethyl acrylate (EtFOSEA), 2-(N-ethylperfluorooctanesulfonamido) ethyl methacrylate (EtFOSEMA), Methylperfluorooctanesulfonamido) ethyl acrylate (MeFOSEA), Methylperfluorooctanesulfonamido) ethyl methacrylate (MeFOSEMA), (Perfluoroalkyl) ethyl acrylate having CF₂ pendant groups from 2-10 units, (Perfluoroalkyl) ethyl methacrylate having CF₂ pendant groups from 2-10 units, Trifluoroethyl acrylate (TFEA) and Trifluoroethyl methacrylate (TFEMA), and combinations thereof.

The siloxane repeat unit may be a monomer selected from the group consisting of dimethylvinyl silyl poly(dimethylsiloxane), divinyl poly(dimethylsiloxane), allyl poly(dimethylslioxane), vinylphenyl poly(dimethylsiloxane), poly(dimethylsiloxane) monomethacrylate (PDMSMA), vinyl terminated [poly(alkyl siloxane)], vinyl terminated [poly(diphenyl siloxane)], vinyl terminated [(poly trifluoropropyl siloxane)], methacryloxypropyl terminated [poly(alkyl siloxane)], methacryloxypropyl terminated [poly(diphenyl siloxane)], methacryloxypropyl terminated [(poly trifluoropropyl siloxane)], mercapto poly(dimethylsiloxane), vinyl terminated poly(dimethylsiloxane), vinyl benzyl terminated poly(dimethyl siloxane), and silsesquioxane or combinations thereof.

The present invention also provides a method of synthesizing a functional fluoropolymer, comprising the steps of:

a) providing a reaction mixture comprising fluorocarbon monomer repeat units, inter-linker monomer repeat units and siloxane monomer repeat units, and a polymerization initiator in a polymerization medium including carbon dioxide; and

b) polymerizing said fluorocarbon monomer repeat units with said interlinker monomer repeat units and said siloxane monomer repeat units wherein the inter-linker monomer repeat units function to copolymerize the siloxane monomer repeat units with the fluorocarbon monomer repeat units to form a functional fluoropolymer comprising a fluorocarbon backbone portion including at least one fluorocarbon repeat unit, a siloxane polymer portion including at least one siloxane repeat unit, and an interlinker polymer portion including at least one interlinker repeat unit, the interlinker polymer portion being covalently bound to both the fluorocarbon backbone portion and the siloxane polymer portion.

In this aspect of the invention the functional fluoropolymer may be cross-linked with a cross-linking agent, and producing a film from the functional fluoropolymer.

The present invention also provides a functional fluoropolymer film comprising a fluorocarbon polymer backbone portion including at least one fluorocarbon monomer repeat unit, an interlinker polymer portion including at least one interlinker monomer repeat unit, and a siloxane polymer portion including at least one siloxane monomer repeat unit, and a crosslinking agent, wherein the fluorocarbon backbone portion is covalently bound to the interlinker polymer portion and the siloxane polymer portion is covalently bound to the interlinker polymer portion.

A further understanding of the functional and advantageous aspects of the invention can be realized by reference to the following detailed description and drawings.

### BRIEF DESCRIPTION OF THE DRAWINGS

Embodiments of the present invention are described in greater detail with reference to the accompanying drawings, in which:

FIG. 1 shows the DSC thermogram of poly(TFE-VAc-PDMSMA), 68/13/19 mol %;

FIG. 2 shows the comparison of TGA curves between (a) crosslinked and (b) un-crosslinked functional fluoropolymers, poly(TFE-VAc-PDMSMA) 55/33/12 mol %;

FIG. 3 shows the prolonged thermal stability test at 200° C. of different functional fluoropolymer compositions determined by mass loss over time for poly(TFE-VAc-PDMSMA): (a) 55/33/12 mol %; (b) 40/57/2 mol %; (c) 68/13/19 mol %;

FIG. 4 shows the stress-strain curves and elastic modulus (EM) for poly(TFE-VAc-PDMSMA), (55-33-12) mol %, with various post-curing times: (a) 16 h, (b) 10 d; (c) 17 d; (d) 30 d; and

FIG. 5 shows an example of a functional fluoropolymer produced in accordance with the present invention.

### DETAILED DESCRIPTION OF THE INVENTION

Terms used in the description of the functional fluoropolymer produced according to the present invention are defined as follows:

Fluoropolymer as used herein refers to all polymers and oligomers containing fluorocarbon in the backbone.

Siloxane monomer as used herein refers to any siloxane monomer containing reactive vinyl group.

Interlinker monomer as used herein is a monomer that allows co-polymerization of fluorocarbon and siloxane monomers. It includes hydrocarbon monomers and/or fluoro-monomers such as vinyl monomers, vinyl terminated oligomers and fluoroacrylate monomers.

scCO₂ refers to liquid and supercritical fluid carbon dioxide.

Co-solvent as used herein refers to all chlorofluorocarbons (CFC) and hydrocarbon solvents that have ester functional groups in their chemical structures.

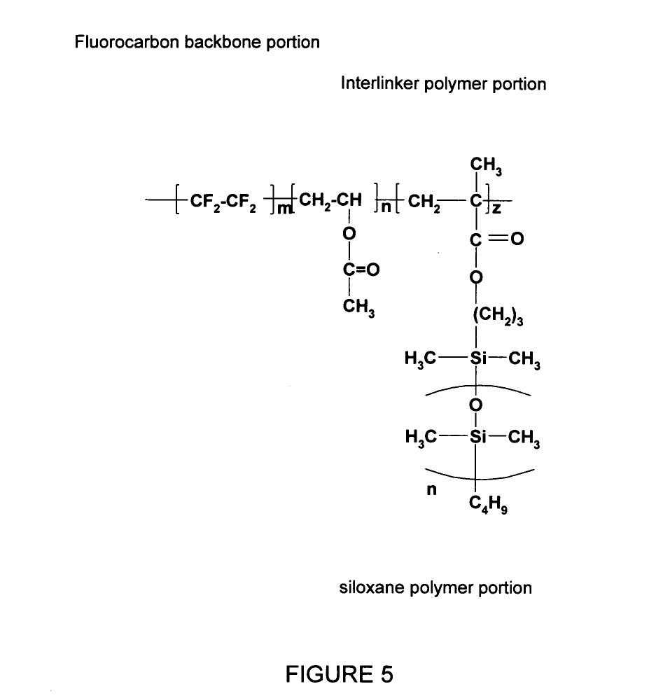

The present invention discloses a functional fluoropolymer comprising a fluorocarbon backbone portion including at least one fluorocarbon repeat unit, a siloxane polymer portion including at least one siloxane repeat unit, and an interlinker polymer portion including at least one interlinker repeat unit, the interlinker polymer portion being covalently bound to both the fluorocarbon backbone portion and the siloxane polymer portion. The formula shown in FIG. 5 shows an example of a functional fluoropolymer produced in accordance with the present invention in which the fluorocarbon backbone portion, interlinker polymer portion and siloxane polymer portions are clearly seen.

The present invention discloses a method of carrying out the polymerization of a fluorocarbon monomer, a siloxane monomer and an interlinker monomer capable of interlinking the fluorocarbon monomer with the siloxane monomer. The steps of the polymerization comprise providing a reaction mixture comprising a fluorocarbon monomer, a siloxane monomer, an interlinker monomer and a polymerization initiator in a polymerization medium comprising carbon dioxide (CO₂). Polymerization medium can optionally comprise a co-solvent that enhances the solubility of the fluoropolymer in carbon dioxide.

Herein, fluoropolymers are defined as fluorocarbon homopolymer, fluorocarbon oligomer, and fluorocarbon copolymer, depending upon the number of fluoromonomers employed.

Fluorocarbon monomers that can be uses in the present invention include any of a wide variety of monomers known to those skilled in the art. Useful fluoromonomers are those that are polymerizable by free radical mechanism and include but are not limited to, fluoroolefines, perfluoroolefines, particularly tetrafluoroethylene (TFE), perfluoro (alkyl vinyl ether), trifluoroethylene, chlorotrifluoroethylene (CTFE), vinylidene fluoride (VF₂), α,β,β-trifluorostyrene, α,β,β-trifluoroaromatics, trifluorovinyl ethers.

Those functional fluoropolymers produced in supercritical CO₂ have linear structures, as disclosed in U.S. Pat. No. 6,730,762 issued to Lousenberg et al., which is incorporated herein by reference in its entirety.

In the process of producing the functional fluoropolymer, the fluorocarbon monomer is typically present in the amount of from about 20 to about 85 percent by weight based upon the entire weight of the feed monomers. Preferably, fluorocarbon monomer is present in the amount from about 40 to about 75 percent by weight based upon the entire weight of the feed monomers.

In the final functional fluoropolymer product the fluorocarbon monomer is present within a range from about 10 to 85 mol percent of the entire fluoropolymer composition, and preferably the fluorocarbon monomer is present within a range from about 30 to 70 mol percent of the entire fluoropolymer composition.

The term “interlinker” refers to a hydrocarbon polymer made from hydrocarbon monomers containing vinyl group capable to react with both the fluorocarbon and the siloxane monomer. The “interlinker” monomers, which are useful in the present invention includes any suitable hydrocarbon monomers known to those skilled in the art. Useful hydrocarbon monomers are those that are polymerizable by a free radical mechanism and include but are not limited to, vinylic monomers capable to dissolve in CO₂ and to copolymerize with fluorocarbon monomers to produce random copolymers with high yield and molecular weight. Examples of useful hydrocarbon monomers include vinyl acetate, vinyl propionate, tertiary butyl acrylate, tertiary butyl methacrylate, acrylic acid, acrylate, and methacrylates, vinyl ethers and vinyl esters. The interlinker monomer is typically present in the amount of from 7 to 50 percent by weight based upon the entire weight of the feed monomers. Preferably, interlinker monomer is present in the amount from 12 to 40 percent by weight based upon the entire weight of the feed monomers. Several hydrocarbon monomers, notably acrylates and acrylic acid, have high intrinsic reactivities with themselves and with other reactive monomers. Typically, they tend to react with themselves rather than with the other fluorocarbon co-monomer.

The term “interlinker” also refers to fluoroacrylate monomers which include esters, amides and acrylic acids such as 1,1-dihydroperfluorooctyl acrylate (FOA), 1,1-dihydroperfluorooctyl methacrylate (FOMA), 2-(N-ethylperfluorooctanesulfonamido) ethyl acrylate (EtFOSEA), 2-(N-ethylperfluorooctanesulfonamido) ethyl methacrylate (EtFOSEMA), methylperfluorooctanesulfonamido) ethyl acrylate (MeFOSEA), methylperfluorooctanesulfonamido) ethyl methacrylate (MeFOSEMA), (perfluoroalkyl) ethyl acrylate having CF₂ pendant groups from 2-10 units long, (perfluoroalkyl) ethyl methacrylate having CF₂ pendant groups from 2-10 units, trifluoroethyl acrylate (TFEA) and trifluoroethyl methacrylate (TFEMA).

In the final functional fluoropolymer product the interlinker monomer is present within a range from about 10 to 70 mol percent of the entire fluoropolymer composition, and preferably the interlinker monomer is present within a range from about 13 to 60 mol percent of the entire fluoropolymer composition.

The siloxane monomer which is useful in the present invention includes any suitable siloxane that contains vinylic group capable of conducting a free radical mechanism with the fluorocarbon and the hydrocarbon interlinker monomers. Examples of siloxane monomers that can be used in the present invention include any siloxane having C₁-C₆ straight or branched chain alkyl, perfluoroalkyl, aryl, or alkyl aryl groups. The siloxane precursor also contains from C₃ to C₄₀ units of straight or branched dimethylsiloxane repeating units. Specific examples of preferred siloxane monomers include, but are not limited to, vinyl functional poly(dimethylsiloxane), divinyl functional poly(dimethylsiloxane), allyl poly(dimethylslioxane), vinylphenyl poly(dimethylsiloxane), vinyl and all acrylate and methacrylate monomers terminated by poly(dimethylslioxane).

Particularly preferred siloxane monomers include methacryloxypropyl functional polydimethylsiloxane (PDMSMA), mercapto functional poly(dimethylsiloxane), vinyl terminated poly(dimethylsiloxane), vinyl benzyl terminated poly(dimethyl siloxane), vinyl terminated and methacrylate terminated cyclic oligomeric silsesquioxane. The siloxane monomer is typically present in the polymerization reaction mixture at a concentration ranging from 10 to 70 percent by weight based upon the entire weight of the feed monomers. Preferably, the siloxane monomer is present in the amount from 20 to 50 percent by weight based upon the entire weight of the feed monomers.

In the final functional fluoropolymer product the siloxane monomer is present within a range from about 2 to 40 mol percent of the entire fluoropolymer composition, and preferably the siloxane monomer is present within a range from about 2 to 20 mol percent of the entire fluoropolymer composition.

Functional fluoropolymers can be obtained by any combination of one or more of fluorocarbon, interlinker and siloxane monomers.

The polymerization medium of the present invention consists essentially of liquid or preferably supercritical carbon dioxide, a polymerization initiator, and optionally a co-solvent.

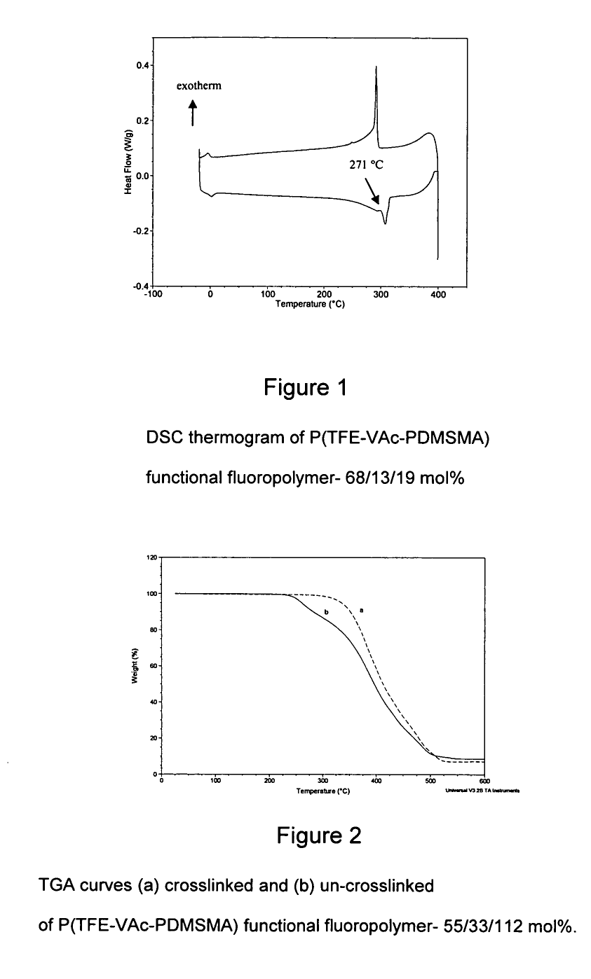

As used herein, the term “supercritical” has its conventional meaning in the art. A supercritical fluid is a substance above its critical temperature and critical pressure. CO₂ facilitates contact of the fluorocarbon, hydrocarbon interlinker and the siloxane monomers such that functional fluoropolymers with single or double narrow glass transition temperature (Tg) may be formed. Furthermore, by using highly reactive hydrocarbon monomers or siloxane monomers, such as methacryloxypropyl functional polydimethylsiloxane (PDMSMA), functional fluoropolymer consisting of microphase separation structure will be produced. Subsequently, using high fraction of fluorocarbon monomers, such as tetrafluoroethylene (TFE), yields functional fluoropolymers with a melting point temperature of 271° C. as shown in FIG. 1. The resulting functional fluoropolymers exhibit microphase separated domains of siloxane and fluorocarbon which are attractive for applications requiring surface activity, such as coatings and paint. Also, the high resistance temperature of fluorocarbon and siloxane monomers yields a functional fluoropolymer useful for applications such as electrophotographic printing applications requiring a polymer coating with high thermal stability. In addition, the siloxane monomers may be very useful both as plasticizers and enhancers of thermal stability and elasticity of a coating film for the above mentioned application. Moreover, siloxane monomers may be used as enhancer of solubility of the final functional fluoropolymer in CO₂.

The polymerization reaction mixture preferably also includes free radical initiators capable of initiating the radical polymerization of the foregoing monomers. The initiator is included in the polymerization medium in a concentration ranging from 0.1 to 5 percent by weight of the feed monomer mixtures. Preferably, the initiator is present in the amount from 0.3 to 2 percent by weight of the entire weight of the feed monomers. Those skilled in this art will be familiar with a number of initiators that are soluble in the polymerization medium. Useful free radical initiator include, but are not limited to the following initiators: diethylperoxydicarbonate (DEPDC), 2,2′ azobis(isobutyronitrile) and dibenzoyl peroxide; other suitable initiators include halogenated free-radical initiators such as fluorocarbon based bis(perfluoro-2-propoxy propionyl) peroxide, [CF₃CF₂CF₂OCF(CF₃)COO]₂, (CF₃CF₂CF₂COO)₂. The preferred initiators are dialkyl peroxydicarbonate (e.g. diethylperoxydicarbonate, [H(CH₂)₂ OCO₂]₂) and 2,2′ Azobis(isobutyronitrile) “AIBN” trade named “Vazo”.

In another embodiment of the invention, a co-solvent may be advantageous for synthesizing more homogeneous functional fluoropolymers. The co-solvent may be very useful when the fraction of fluorocarbon monomer is relatively high. This co-solvent may enhance the solubility of any fluorocarbon macro-radical block formed during the polymerization steps. The co-solvent that may be used in the present invention includes any suitable solvent known to those skilled in the art. Useful co-solvents can be any chlorofluorocarbon (CFC); particularly 1,1,2- trichlorotrifluoroethane (Freon 113) or hydrocarbons; particularly ethyl acetate and butyl acetate. The co-solvent can be used in a liquid phase within a concentration of about 1 to 30 percent based on the entire weight of the monomer mixtures. Preferably, the co-solvent used within a concentration of between 5 to 10 percent based on the entire weight of the monomer mixture.

The polymerisation medium of the present invention comprises carbon dioxide or a mixture of CO₂ with halofluorocarbon (such as a chlorofluorocarbon, CFC) co-solvents such as 1,1,2 trichlorotrifluoroethane (Freon 113). Carbon dioxide can be used in a liquid, vapor or supercritical phase wherein the critical temperature is at least 31° C. and the pressure of carbon dioxide is at least 71 bars. Preferably, the reaction temperature will be between 31° C. and 90° C. and the pressure will be between 50 bars (750 PSI) and 600 (9000 PSI) bars. Preferably, the reaction temperature is between 40° C. and 70° C. and the pressure is between 200 bars (3000 PSI) and 400 bars (6000 PSI).

The polymerisation step of the present invention can be carried out by polymerisation methods using apparatus and conditions known to those skilled in this art. For example, these steps may be carried out batch-wise or continuously with thorough mixing of the reactants (monomer or monomers, initiator, co-solvent) in any appropriate high-pressure vessel. Preferably, the functional fluoropolymers are prepared batch-wise in a suitable high pressure reaction vessel. In particular, it has been found that employing a continuous reactor may be useful to control fluoropolymer composition distribution and may be useful in the copolymerization of two or more monomers with different reactivities.

Typically, the polymerization can be carried out by charging the reaction vessel with monomers, initiators and carbon dioxide, closing the reaction vessel, and bringing the reaction mixture to an appropriate temperature and pressure. In the above embodiment, it should be noted that depending on the reactivities of monomers, a part of the monomers may be introduced into the reactor vessel and heated to the polymerization temperature and brought to the polymerization pressure, with additional reaction mixture being added at a rate corresponding to the rate of polymerization. As an alternative, the initiator, and some of the monomers may be initially introduced into the reaction vessel and brought to an appropriate temperature and pressure, with additional monomers being added at the rate at which polymerization proceeds.

Typically, the polymerization reaction mixture is allowed to polymerize for between about 2 and 72 hours, and preferably is stirred as the reaction proceeds. When the polymerization is complete, the functional fluoropolymer may be separated from the reaction mixture by venting the CO₂. Thereafter, the polymer may be collected by physical isolation. It may be desirable, for some applications, to purify the resulting functional fluoropolymer before further processing. For example, it may be desirable to remove residual co-solvent and un-reacted monomers. The functional fluoropolymer may be washed in a wash fluid comprising CO₂ before or after venting the polymerization medium to atmospheric pressure. Alternatively, the functional fluoropolymer may be purified by precipitation or preferably blending in a solvent or solvent mixture which is a solvent for the monomer but not for the functional fluoropolymer. For example, such solvents or solvent mixture may include but are not limited to, water, methanol, a mixture of water and methanol, a mixture of water and ethanol, and acetone. In addition, the functional fluoropolymer of the present invention may be retained in the carbon dioxide polymerization medium or re-dispersed in carbon dioxide medium, and sprayed onto a surface. After the carbon dioxide evaporates, the polymer forms a coating on the surface. Alternatively, the functional fluoropolymer formed by the present invention can also be used to form films, fibers, matrices for composite materials. The functional fluoropolymer can also be crosslinked by the addition of any suitable crosslinking agent such as peroxides, bisphenol-AF quaternary phosphonium chloride or amino alkyls compounds.

The functional fluoropolymer of the present invention may contain a broad range of fluorocarbon repeat units and may be soluble in common organic solvents such as halocarbon, tetrahydrofuran, methyl ethyl ketone. In addition, the fluoropolymers may have weight average molar masses between 10⁴ and 10⁶ g mol⁻¹.

More particularly, the functional fluoropolymer disclosed herein has an average molecular weight (Mw) between about 5,000 g/mol and about 800,000 g/mol, measured in equivalent to polystyrene standards. Preferably the Mw is between about 25,000 g/mol and about 300,000 g/mol, and more preferably the Mn is between about 15,000 g/mol and about 200,000 g/mol.

The functional fluoropolymers have two Tg's: one between 20 and 60° C. and the other between −110 and −130° C. For P(TFE/VAc/PDMSMA) the Tg for the P(TFE-VAc) domain is between about 25° C. and about 40° C. and the Tg of PPDMSMA domain is between about −110 and about −130° C. For P(TFE/VAc/PDMSMA) the Tg for the P(TFE-VAc) domain is between about 25 ° C. and about 40° C. and the Tg of PPDMSMA domain is between about −118 and about −122° C. For P(CTFE/VAc/PDMSMA) the Tg for P(CTFE/VAc) domain is between about 50 and about 60° C. and the Tg for the PPDMSMA domain is between about −110° C. and about −130° C. P(CTFE/VAc/PDMSMA) the Tg for P(CTFE/VAc) domain is between about 50 and about 60° C. and the Tg for the PPDMSMA domain is between about −118° C. and about −122° C.

For P(TFE/VAc/PDMSMA) functional fluoropolymers will exhibit PTFE domains having a melting temperature (Tₘ) between 220° C. and 350° C. P(TFE/VAc/PDMSMA) functional fluoropolymers will exhibit PTFE domains having a melting temperature (Tₘ) between 230° C. and 280° C.

The functional fluoropolymers of the present invention may have one of many forms including: solid, liquid, viscous liquid, gel, solution, powder, film, suspension, latex and colloidal just to mention some non-limiting examples. These forms may be linear, branched or crosslinked polymers.

The functional fluoropolymer of the present invention may be formulated or applied as a coating or a surface modifier by casting, spin-coating, dip-coating, spray coating, co-extrusion, injection molded, among others.

The functional fluoropolymer of the present invention may be used in those applications that currently have fluoropolymers and/or siloxanes such as (but not limited to) release agents, coatings (either protective or barrier coatings), sealants, surface-modifying agents, including a surfactant or a detergent, an additive, a carrier/matrix/support for the release of particulates over time, including but not limited to small molecules and/or therapeutic agents. The functional fluoropolymers of the present invention may be used in paints, as photoresists, in biomedical applications, such as coatings for pacemaker leads or vascular grafts.

The following examples are provided to illustrate the present invention, and should not be construed as limiting thereof. In these examples, ¹H and ¹⁹F means nuclear magnetic resonance “NMR” spectra were obtained in CDCl₃ on a Varian Gemini spectrometer at 399.95 and 376.30 MHz, respectively, using α,α,α-trifluorotoluene (Aldrich, Ontario, Canada) as references. The fluoropolymer molar masses were characterized by means of gel permeation chromatography “GPC”. The GPC (Water U6K injector, 510 pump) was equipped with a refractive index detector (Water 2410) and a series of Ultrastyragel columns (Water 10⁶, 10⁴ and 500 Å). Using an tetrahydrofuran mobile phase (1 mL min⁻¹), polymer molar masses were calculated relative to polystyrene standards (Aldrich, Ontario, Canada). Glass transition temperatures (Tg) and melting point (Tₘ) were measured using a TA Q1000 differential scanning calorimeter. Thermogravimetric analysis (TGA) was performed using a TA Q50.

“VAc” means vinyl acetate, “TFE” means tetrafluoroethylene, “CTFE” means chluorotrifluoroethylene (Aldrich, Ontario, Canada), “PDMSMA” means methacryloxypropyl functional poly(dimethylsiloxane) (Gelest, Pa, USA). TFE was prepared by vacuum pyrolysis of polytetrafluoroethylene (Aldrich, Ontario, Canada) according to Hunadi et al. (synthesis 1982), stored, de-inhibited and manipulated according to Lousenberg et al (U.S. Pat. No. 6,730,762 B2) and Baradie et al (Macromolecules 2002). The diethyl peroxydicarbonate (DEPDC) initiator was prepared using a published procedure (Strain et al. J. Am. Soc. 1950). “VAzo” means AIBN (2,2-isobis (isobutyronitrile)) initiator (Dupont Co, Delaware, US) which was recrystallized twice from methanol. SFC purity CO₂ was obtained from Matheson (Ontario, Canada). Acetone, Methanol, Ethanol, THF, Dichloromethane were obtained from Caledon (Ontario, Canada). Methyl ethyl ketone was obtained from Aldrich (Ontario, Canada). Water was de-ionized and distilled from Millipore Milli-RO 10 plus and Milli-Q UF plus (Bedford, Mass., USA) systems and used at 18 MΩ) resistance.

The present invention will now be illustrated by the following non-limiting examples.

### EXAMPLE 1

TFE/VAc/PDMSMA Functional Fluoropolymers without Co-Solvent “Freon 113”

This example illustrates the synthesis of TFE/VAc/PDMSMA functional fluoropolymers in supercritical fluid CO₂ using AIBN “Vazo64” initiator. Polymerizations were carried out in a custom built, 50 mL, stainless steel, high pressure reactor. The head of the reactor was fitted with a Parr (Moline, Ill.) A1120HC magnetic drive. The base of the reactor was heated by a removable stainless steel water jacket connected to a temperature controlled water bath (model 1160A, VWR, Ontario, Canada).

The desired amount of initiator (AIBN “Vazo64”) was introduced into the reactor. The reactor was sealed and evacuated (P≦0.01 mmHg). The base of the reactor was then chilled to approximately −50° C., using a liquid nitrogen bath. Meanwhile, the desired amount of liquid monomers VAc and PDMSMA were mixed by shaking and then transferred by a canula to the evacuated reactor. The reactor was evacuated again to degas liquid monomers. With stirring, the desired amount of TFE (gas monomer) was added to the reactor for a total monomer weight of 20 g. Then, CO₂ was added and maintained at pressure of 20 to 40 bar while warming the reactor to approximately 5° C. At this temperature, CO₂ was condensed into the reactor at a pressure of 55±5 bar over 1 to 2 minutes. The preheated water jacket was placed around the base of the reactor. The reactor was then heated to the desired polymerization temperature (65±1° C.). Pressures were initially between 330 and 350 bar. The polymerizations were stopped after 72 hours by first cooling the reactor to room temperature. The reactor was then slowly vented to atmospheric pressure. At a pressure less than 50 bar, the stirring was stopped as the polymer coagulated and started to bind the stir shaft. The reactor was then fully vented to atmospheric pressure and opened. The white and tacky solid polymer formed in the reactor, was dissolved in dichloromethane or methyl ethyl ketone and quantitatively removed and precipitated into a mixture of methanol/water to give the final purified polymer. Some functional fluoropolymers were subjected to further purification by blending them in ice-cold water/methanol (400 mL, 1:1 v/v). The polymer was collected by vacuum filtration and washed several time with a mixture of water/methanol before drying (50° C., P<0.1 mmHg). Table 1 summarizes the results for a range of functional fluoropolymer composition. All the resulting functional fluoropolymers had Mw greater than 29,000 g/mol and PDI between 1.4 and 3.7. In addition, when the interlinker monomer, VAc, was not used, only poly(PDMSMA) homopolymer was produced (Sample 1). Here we can clearly see that the interlinker plays a major role in copolymerizing the fluorocarbon monomer with the siloxane monomer as shown in Samples 2-4.

TABLE 1
TFE/VAc/PDMSMA Functional Fluoropolymer without “Freon113” co-solvent

| | Sample 1 | Sample 2 | Sample 3 | Sample 4 |
|---|---|---|---|---|
| TFE/VAc/PDMSMA in feed (mol | 69/0/31 | 76/17/6 | 77/21/3 | 87/10/3 |
| %) | | | | |
| Yield (wt %)^{a} | 64 | 38 | 31 | 38 |
| Mw/Mn/PDI (kg mol⁻¹) | 89/31/2.8 | 57/26/2.2 | 61/22/2.8 | 38/21/1.8 |
| Initiator (wt %) | | | | |
| AIBN “Vazo” | 0.6 | 0.6 | 0.6 | 0.6 |
| Composition | | | | |
| TFE/VAc/PDMSMA | 0/0/100 | 50/29/21 | 49/44/6 | 52/38/9 |
| In the polymer (mol %)^{b} | | | | |
| Glass Transition (T_{g}, ° C.) | | | | |
| P(TFE-VAc) domain | — | Undetected Tg | 36.4 | 29.8 |
| P(PDMSMA) domain | −121 | −120 | −118 | −118 |

### EXAMPLE 2

TFE/VAc/PDMSMA Functional Copolymers with Co-Solvent “Freon 113”

This example illustrates the synthesis of TFE/VAc/PDMSMA functional copolymers in supercritical fluid CO₂ using AIBN “VAzo64” initiator and the co-solvent Freon 113. Polymerizations were carried out in a custom build, 50 mL, stainless steel, and high pressure reactor. The head of the reactor was fitted with a Parr (Moline, Ill.) A1120HC magnetic drive. The base of the reactor was heated by a removable stainless steel water jacket connected to a temperature controlled water bath (model 1160A, VWR, Ontario, Canada).

The desired amount of initiator (AIBN “Vazo64”) was introduced into the reactor. The reactor was sealed and evacuated (P≦0.01 mmHg). The base of the reactor was then chilled to approximately −50° C., using a liquid nitrogen bath. Meanwhile, the desired amount of liquid monomers VAc, PDMSMA and the co-solvent Freon 113 were mixed by shaking and then transferred by a canula to the evacuated reactor. The reactor was evacuated again to degas liquid monomers. With stirring, the desired amount of TFE (gas monomer) was added to the reactor for a total monomer weight of 20 g. Then, CO₂ was added and maintained at pressure of 20 to 40 bar while warming the reactor to approximately 5° C. At this temperature, CO₂ was condensed into the reactor at a pressure of 55±5 bar over 1 to 2 minutes. The preheated water jacket was placed around the base of the reactor. The reactor was then heated to the desired polymerization temperature (65±1° C.). Pressures were initially between 330 and 350 bar. The polymerizations were stopped after 72 hours by first cooling the reactor to room temperature. The reactor was then slowly vented to atmospheric pressure. At a pressure less than 50 bar, the stirring was stopped as the polymer coagulated and started to bind the stir shaft. The reactor was then fully vented to atmospheric pressure and opened. The polymer formed in the reactor is a viscous polymer and it is purified by washing several times with methanol. The polymer was collected by centrifugation before drying (50° C., P<0.1 mmHg). The results for TFE/VAc/PDMSMA functional fluoropolymer are shown in Table 2.

When the inter-linker monomer, VAc, was not used, only poly(PDMSMA) homopolymer was produced (sample 5). The co-solvent increases the yield and Mw when data in Tables 1 and 2 are compared, specifically Sample 3 (Table 1) and Sample 7 (Table 2).

TABLE 2
TFE/VAc/PDMSMA Functional Fluoropolymer with “Freon113” co-solvent

| | Sample 5 | Sample 6 | Sample 7 | Sample 8 | Sample 9 |
|---|---|---|---|---|---|
| TFE/VAc/PDMSMA in feed | 94/0/6 | 64/33/3 | 77/20/3 | 88/9/3 | 94/3.5/2.5 |
| (mol %) | | | | | |
| Yield (wt %)^{a} | 25 | 64 | 56 | 41 | 32 |
| Mw/Mn/PDI (kg mol⁻¹) | 27/15/1.8 | 173/53/3.3 | 130/36/3.6 | 87/35/2.5 | 29/20.5/1.4 |
| Initiator (wt %) | | | | | |
| AIBN “Vazo” | 0.6 | 0.6 | 0.6 | 0.6 | 0.6 |
| Co-solvent (wt %) | | | | | |
| (Freon 113) | 10 | 10 | 10 | 10 | 10 |
| Composition | | | | | |
| TFE/VAc/PDMSMA | 0/0/100 | 40/57/3 | 46/47/7 | 55/33/12 | 68/13/19 |
| In the polymer (mol %)^{b} | | | | | |
| Glass Transition (T_{g}, ° C.) | | | | | |
| P(TFE-VAc) domain | — | 38 | 31 | 28 | — |
| P(PDMSMA) domain | −122 | −119 | −118 | −120 | −121 |
| Melting temperature (Tₘ, C.) | | | | 235 | 271 |

### EXAMPLE 3

CTFE/VAc/PDMSMA Functional Copolymers with Co-Solvent “Freon 113”

This example illustrates the synthesis of CTFE/VAc/PDMSMA functional copolymers in supercritical fluid CO₂ using AIBN “VAzo64” initiator. Polymerizations were carried out in a custom build, 50 mL, stainless steel, and high pressure reactor. The head of the reactor was fitted with a Parr (Moline, Ill.) A1120HC magnetic drive. The base of the reactor was heated by a removable stainless steel water jacket connected to a temperature controlled water bath (model 1160A, VWR, Ontario, Canada).

The desired amount of initiator (AIBN “Vazo64”) was introduced into the reactor. The reactor was sealed and evacuated (P≦0.01 mmHg). The base of the reactor was then chilled to approximately −50° C., using a liquid nitrogen bath. Meanwhile, the desired amount of liquid monomers VAc, PDMSMA and the co-solvent Freon 113 were mixed by shaking and then transferred by a canula to the evacuated reactor. The reactor was evacuated again to degas liquid monomers. With stirring, the desired amount of CTFE (gas monomer) was added to the reactor for a total monomer weight of 20 g. Then, CO₂ was added and maintained at pressure of 20 to 40 bar while warming the reactor to approximately 5° C. At this temperature, CO₂ was condensed into the reactor at a pressure of 55±5 bar over 1 to 2 minutes. The preheated water jacket was placed around the base of the reactor. The reactor was then heated to the desired polymerization temperature (65±1° C.). Pressures were initially between 330 and 350 bar. The polymerizations were stopped after 72 hours by first cooling the reactor to room temperature. The reactor was then slowly vented to atmospheric pressure. At a pressure less than 50 bar, the stirring was stopped as the polymer coagulated and started to bind the stir shaft. The reactor was then fully vented to atmospheric pressure and opened. The polymer formed in the reactor is a viscous polymer and it is purified by washing several times with methanol. The polymer was collected by centrifugation before drying (50° C., P<0.1 mmHg). The results for CTFE/VAc/PDMSMA functional fluoropolymer are shown in Table 3.

When the inter-linker monomer, VAc, was not used, only poly(PDMSMA) homopolymer was produced (sample 10).

TABLE 3

| | Sample 10 | Sample 11 | Sample 12 | Sample 13 |
|---|---|---|---|---|
| CTFE/VAc/PDMSMA | 87/0/13 | 61/36/3 | 79/18/3 | 88/9/3 |
| in feed (mol %) | | | | |
| Yield (wt %)^{a} | 25 | 56 | 32 | 19 |
| Mw/Mn/PDI (kg mol⁻¹) | 25/14/1.8 | 134/49/2.7 | 60/25/2.4 | 15/9/1.7 |
| Initiator (wt %) | | | | |
| AIBN “Vazo” | 0.6 | 0.6 | 0.6 | 0.6 |
| Co-solvent (wt %) | | | | |
| (Freon 113) | 10 | 10 | 10 | 10 |
| Composition | | | | |
| CTFE/VAc/PDMSMA | 0/0/100 | 37/59/4 | 37/55/8 | 40/36/24 |
| In the polymer (mol %)^{b} | | | | |
| Glass Transition | | | | |
| (T_{g}, ° C.) | | | | |
| P(CTFE-VAc) domain | — | 55.7 | 52.1 | — |
| P(PDMSMA) domain | −122 | −118 | −119 | −122 |

### EXAMPLE 4

TFE/VAC/PDMSMA Functional Fluoropolymer Crosslinked Film

The fluorosilicone polymer prepared in Example 1 (3.6 g) is dissolved in 15 mL methylethyl ketone at room temperature for 5 hours. To the polymer solution, 0.112 g of MgO, 0.22 g of Ca(OH)₂ and 0.08 g of bisphenol-AF/Quaternary phosphonium chloride mixture were added, homogenizing for at least 15 hours prior to casting on a Teflon-coated glass sheet. The solvent evaporated overnight and the dried film was pre-cured at 145° C. for 30-60 minutes then post-cured at 204° C. for 16 hours.

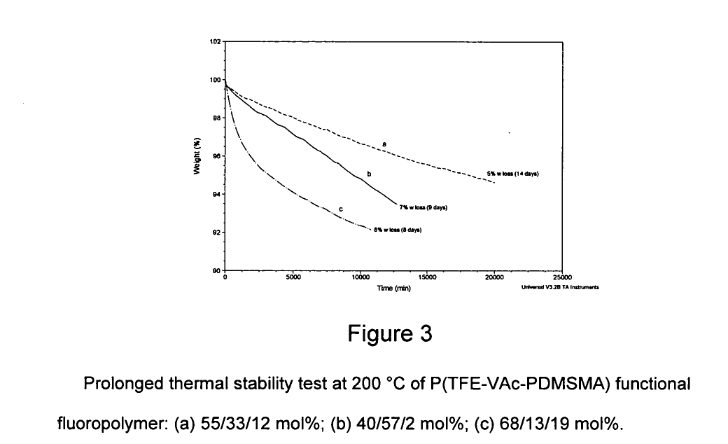

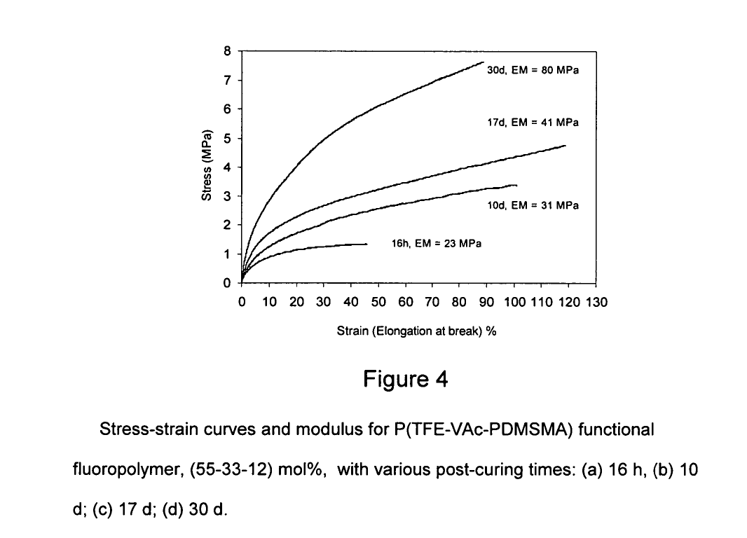

FIG. 2 shows the TGA curves between a cross-linked and uncrossedlinked functional fluoropolymer. The cross-linked film shows greater thermal stability than its uncrosslinked homologue, thus indicating the importance of cross-linking of the film. Further, FIG. 3 and FIG. 4 show the optimal thermal stability at 200° C. and elastic Modulus of the film composition: TFE of 55 mol %, VAc of 33 mol % and PDMSMA of 12 mol %, indicating that for certain applications the film can meet and be adjusted accordingly to the application requiring stringent properties. In some applications, it's important for the fluoropolymer to meet temperatures above 200° C. while maintaining good mechanical properties. The novel functional fluoropolymer film addresses this issue wherein the polymer remains stable up to 200° C. for a prolonged period of time when crossed linked.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A functional fluoropolymer comprising a fluorocarbon backbone portion including at least one fluorocarbon repeat unit, a siloxane polymer portion including at least one siloxane repeat unit, and an interlinker polymer portion including at least one interlinker repeat unit, the interlinker polymer portion being covalently bound to both the fluorocarbon backbone portion and the siloxane polymer portion.

2. The functional fluoropolymer of claim 1, wherein the fluorocarbon repeat unit is a monomer selected from the group consisting of fluoroolefinic monomers, perfluoroolefinic monomers, and combinations thereof.

3. The functional fluoropolymer of claim 1, wherein the fluorocarbon repeat unit is a monomer selected from the group consisting of tetrafluoroethylene, trifluoroethylene, chlorotrifluoroethylene (CTFE), vinylidene fluoride (VF₂), α,β,β-trifluoroaromatic monomers and trifluorovinyl ether monomers.

4. The functional fluoropolymer of claim 1 wherein the interlinker repeat unit is a monomer selected from the group consisting of alkene or diene monomers, styrenic monomers, maleic anhydride monomers, acrylic and methacrylic monomers, olefinic monomers, tertiary butyl acrylate, vinyl acetate, vinyl propionate, vinylic ethers, vinylic esters, and combinations thereof.

5. The functional fluoropolymer of claim 1 wherein the interlinker repeat unit is a fluoroacrylate monomer selected from the group consisting of 1,1-dihydroperfluorooctyl acrylate (FOA), 1,1-dihydroperfluorooctyl methacrylate (FOMA), 2-(N-ethylperfluorooctanesulfonamido) ethyl acrylate (EtFOSEA), 2-(N-ethylperfluorooctanesulfonamido) ethyl methacrylate (EtFOSEMA), Methylperfluorooctanesulfonamido) ethyl acrylate (MeFOSEA), Methylperfluorooctanesulfonamido) ethyl methacrylate (MeFOSEMA), (Perfluoroalkyl) ethyl acrylate having CF₂ pendant groups from 2-10 units, (Perfluoroalkyl) ethyl methacrylate having CF₂ pendant groups from 2-10 units, Trifluoroethyl acrylate (TFEA) and Trifluoroethyl methacrylate (TFEMA), and combinations thereof.

6. The functional fluoropolymer of claim 1 wherein the siloxane repeat unit is a monomer selected from the group consisting of dimethylvinyl silyl poly(dimethylsiloxane), divinyl poly(dimethylsiloxane), allyl poly(dimethylslioxane), vinylphenyl poly(dimethylsiloxane), poly(dimethylsiloxane) monomethacrylate (PDMSMA), vinyl terminated [poly(alkyl siloxane)], vinyl terminated [poly(diphenyl siloxane)], vinyl terminated [(poly trifluoropropyl siloxane)], methacryloxypropyl terminated [poly(alkyl siloxane)], methacryloxypropyl terminated [poly(diphenyl siloxane)], methacryloxypropyl terminated [(poly trifluoropropyl siloxane)], mercapto poly(dimethylsiloxane), vinyl terminated poly(dimethylsiloxane), vinyl benzyl terminated poly(dimethyl siloxane), silsesquioxane and combinations thereof.

7. The functional fluoropolymer of claim 2 wherein the fluorocarbon monomer is present within a range from about 10 to 85 mol percent of an entire composition of functional fluoropolymer.

8. The functional fluoropolymer of claim 2 wherein the fluorocarbon monomer is present within a range from about 30 to 70 mol percent of an entire composition of functional fluoropolymer.

9. The functional fluoropolymer of claim 4 wherein the interlinker monomer is present within a range from about 10 to 70 mol percent of an entire composition of functional fluoropolymer.

10. The functional fluoropolymer of claim 4 wherein the interlinker monomer is present within a range from about 13 to 60 mol percent of an entire composition of functional fluoropolymer.

11. The functional fluoropolymer of claim 6 wherein the siloxane monomer is present within a range from about 2 to 40 mol percent of an entire composition of functional fluoropolymer.

12. The functional fluoropolymer of claim 6 wherein the siloxane monomer is present within a range from about 2 to 20 mol percent of an entire composition of functional fluoropolymer.

13. The functional fluoropolymer of claim 1 comprising P(TFE-VAc) domains having a glass transition temperature (T_{g}) between about 20° C. and about 60° C.

14. The functional fluoropolymer of claim 13 wherein T_{g} is between 25° C. and 40° C.

15. The functional fluoropolymer of claim 1 comprising P(PDMSMA) domains having a glass transition temperature (T_{g}) between about −110° C. and about −130° C.

16. The functional fluoropolymer of claim 15 wherein T_{g} is between −118° C. and −122° C.

17. The functional fluoropolymer of claim 1 comprising PTFE domains having a melting temperature (Tₘ) between 220° C. and 350° C.

18. The functional fluoropolymer of claim 17 wherein Tₘis between 230° C. and 280° C.

19. The functional fluoropolymer of claim 1 having an average molecular weight (Mw) between about 5,000 g/mol and about 800,000 g/mol, measured in equivalent to polystyrene standards.

20. The functional fluoropolymer of claim 19 wherein the Mw is between about 25,000 g/mol and about 300,000 g/mol.

21. The functional fluoropolymer of claim 1 having an average number molecular weight (Mn) between about 5,000 g/mol and about 400,000 g/mol in equivalent to polystyrene standards.

22. The functional fluoropolymer of claim 21 wherein Mn is between about 15,000 g/mol and about 200,000 g/mol.

23. The functional fluoropolymer of claim 1 having a linear structure.

24. The functional fluoropolymer of claim 1 produced in a form selected from the group consisting of solid, liquid, viscous liquid, gel, solution, powder, film, suspension, latex, and colloidal particles.

25. The functional fluoropolymer of claim 24 which may be any one of a linear, branched and crosslinked polymer.

26. The functional fluoropolymer of claim 1 formulated to be applied as a coating or a surface modifier by casting, spin-coating, dip-coating, spray coating, co-extrusion or injection molding.

27. The functional fluoropolymer of claim 1 for use as additives in paints.

28. The functional fluoropolymer of claim 1 for use as release agents, protective coatings, barrier coatings, sealants, surface-modifying agents, surfactants, detergents, paint additives, carrier/matrix/supports for the release of particulates over time, said particulates being selected from the group consisting of small molecules, or therapeutic agents.

29. The functional fluoropolymer of claim 1 for use as a vascular graft.

30. The functional fluoropolymer of claim 29 formed into a shape desired for use as said vascular graft by any one of extrusion, casting and molding.

31. A method of synthesizing a functional fluoropolymer, comprising the steps of:
a) providing a reaction mixture comprising fluorocarbon monomer repeat units, inter-linker monomer repeat units and siloxane monomer repeat units, and a polymerization initiator in a polymerization medium including carbon dioxide; and
b) polymerizing said fluorocarbon monomer repeat units with said interlinker monomer repeat units and said siloxane monomer repeat units wherein the inter-linker monomer repeat units function to copolymerize the siloxane monomer repeat units with the fluorocarbon monomer repeat units to form a functional fluoropolymer comprising a fluorocarbon backbone portion including at least one fluorocarbon repeat unit, a siloxane polymer portion including at least one siloxane repeat unit, and an interlinker polymer portion including at least one interlinker repeat unit, the interlinker polymer portion being covalently bound to both the fluorocarbon backbone portion and the siloxane polymer portion.

32. The method of claim 31 wherein the fluorocarbon monomer repeat unit is selected from the group consisting of fluoroolefinic monomers, perfluoroolefinic monomers, tetrafluoroethylene, trifluoroethylene, chlorotrifluoroethylene (CTFE), vinylidene fluoride (VF₂), α,β,β-trifluoroaromatic monomers, trifluorovinyl ether monomers, and combinations thereof.

33. The method of claim 31 wherein the siloxane monomer repeat unit is selected from the group consisting of dimethylvinyl silyl poly(dimethylsiloxane), divinyl poly(dimethylsiloxane), allyl poly(dimethylslioxane), vinylphenyl poly(dimethylsiloxane), poly(dimethylsiloxane) monomethacrylate (PDMSMA), mercapto poly(dimethylsiloxane), vinyl terminated poly(dimethylsiloxane), vinyl benzyl terminated poly(dimethyl siloxane), and combinations thereof.

34. The method of claim 31 wherein the interlinker monomer repeat unit is selected from the group consisting of alkene or diene monomers, styrenic monomers, maleic anhydride monomers, acrylic and methacrylic monomers, olefinic monomers, and combinations thereof.

35. The method of claim 31 wherein the interlinker monomer repeat unit is selected from the group consisting of tertiary butyl acrylate, vinyl acetate, vinyl propionate, vinylic ethers, vinylic esters, 1,1-dihydroperfluorooctyl acrylate (FOA), 1,1-dihydroperfluorooctyl methacrylate (FOMA), 2-(N-ethylperfluorooctanesulfonamido) ethyl acrylate (EtFOSEA), 2-(N-ethylperfluorooctanesulfonamido) ethyl methacrylate (EtFOSEMA), Methylperfluorooctanesulfonamido) ethyl acrylate (MeFOSEA), Methylperfluorooctanesulfonamido) ethyl methacrylate (MeFOSEMA), (Perfluoroalkyl) ethyl acrylate having CF₂ pendant groups from 2-10 units, (Perfluoroalkyl) ethyl methacrylate having CF₂ pendant groups from 2-10 units, Trifluoroethyl acrylate (TFEA) and Trifluoroethyl methacrylate (TFEMA), and combinations thereof.

36. The method according to claim 31 wherein said initiator is 2,2-azobis(isobutyronitrile) trade named Vazo64.

37. The method according to claim 31 wherein said initiator is diethylperoxydicarbonate (DEPDC).

38. The method according to claim 31 wherein said polymerization medium comprises liquid carbon dioxide.

39. The method according to claim 31 wherein said polymerization medium comprises supercritical carbon dioxide.

40. The method according to claim 31 wherein said reaction mixture includes a co-solvent.

41. The method according to claim 40 wherein said co-solvent is selected from the group consisting of 1,1,2, trifluoro-trichloroethane, ethyl acetate and butyl acetate.

42. The method of claim 40 wherein said co-solvent has a concentration ranging from about 2 w/w % to 10 w/w % of the total weight of monomer.

43. The method according to claim 39 wherein said functional fluoropolymer produced has a linear structure.

44. The method of claim 31 including the steps of cross-linking the functional fluoropolymer with a cross-linking agent, and producing a film from the functional fluoropolymer.

45. The method according to claim 44 wherein the cross-linking agent is a curative package including bisphenol-AF/Quaternary phosphonium chloride, magnesium oxide (MgO) and calcium hydroxide Ca(OH)₂.

46. A functional fluoropolymer film comprising a fluorocarbon polymer backbone portion including at least one fluorocarbon monomer repeat unit, an interlinker polymer portion including at least one interlinker monomer repeat unit, and a siloxane polymer portion including at least one siloxane monomer repeat unit, and a crosslinking agent, wherein the fluorocarbon backbone portion is covalently bound to the interlinker polymer portion and the siloxane polymer portion is covalently bound to the interlinker polymer portion.

47. The functional fluoropolymer film of claim 46 wherein the fluorocarbon monomer repeat unit is selected from the group consisting of fluoroolefinic monomers, perfluoroolefinic monomers, tetrafluoroethylene, trifluoroethylene, chlorotrifluoroethylene (CTFE), vinylidene fluoride (VF₂), α,β,β,-trifluoroaromatic monomers, trifluorovinyl ether monomers, and combinations thereof.

48. The functional fluoropolymer film of claim 46 wherein the interlinker monomer repeat unit is selected from the group consisting of alkene or diene monomers, styrenic monomers, maleic anhydride monomers, acrylic and methacrylic monomers, olefinic monomers, tertiary butyl acrylate, vinyl acetate, vinyl propionate, vinylic ethers, vinylic esters, and combinations thereof.

49. The functional fluoropolymer film of claim 46 wherein the interlinker monomer repeat unit is a fluoroacrylate monomer selected from the group consisting of 1,1-dihydroperfluorooctyl acrylate (FOA), 1,1-dihydroperfluorooctyl methacrylate (FOMA), 2-(N-ethylperfluorooctanesulfonamido) ethyl acrylate (EtFOSEA), 2-(N-ethylperfluorooctanesulfonamido) ethyl methacrylate (EtFOSEMA), Methylperfluorooctanesulfonamido) ethyl acrylate (MeFOSEA), Methylperfluorooctanesulfonamido) ethyl methacrylate (MeFOSEMA), (Perfluoroalkyl) ethyl acrylate having CF₂ pendant groups from 2-10 units, (Perfluoroalkyl) ethyl methacrylate having CF₂ pendant groups from 2-10 units, Trifluoroethyl acrylate (TFEA) and Trifluoroethyl methacrylate (TFEMA), and combinations thereof.

50. The functional fluoropolymer film of claim 46 wherein the siloxane monomer repeat unit is selected from the group consisting of dimethylvinyl silyl poly(dimethylsiloxane), divinyl poly(dimethylsiloxane), allyl poly(dimethylslioxane), vinylphenyl poly(dimethylsiloxane), poly(dimethylsiloxane) monomethacrylate (PDMSMA), mercapto poly(dimethylsiloxane), vinyl terminated poly(dimethylsiloxane), vinyl benzyl terminated poly(dimethyl siloxane) and combinations thereof.

51. The functional fluoropolymer film of claim 46 wherein the cross-linking agent is a curative package comprising bisphenol-AF/Quaternary phosphonium chloride, magnesium oxide (MgO) and calcium hydroxide (Ca(OH)₂.
